(19) United States
(12) Patent Application Publication
(10) Pub. No.: US 2008/0125204 A1
(43) Pub. Date: May 29, 2008

(54) GAMING APPARATUS AND PLAYING METHOD OF CARD GAME

(75) Inventor: Yukinori INAMURA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/936,313

(22) Filed: Nov. 7, 2007

(30) Foreign Application Priority Data
Nov. 27, 2006 (JP) 2006-319092

(51) Int. Cl. A63F 13/00

(52) U.S. Cl. 463/11

(57) ABSTRACT

A gaming apparatus according to the present invention including: a display capable of displaying a plurality of cards, a sugoroku (Japanese board game like “Snakes and Ladders”) board provided with a plurality of spaces, and a player's piece; an input switch capable of making an input of a hold and/or a change from the player; and a controller, the controller programmed to conduct the processing of: (a) displaying the plurality of cards, the sugoroku board, and the player's piece to the display; (b) detecting the input of a hold and/or a change from the input switch; (c) exchanging a card in accordance with the detection; (d) moving the player's piece, when a combination of a plurality of cards after the exchange is a predetermined combination, on the sugoroku board by the number of spaces corresponding to the combination of the plurality of cards; and (e) providing an award corresponding to the space at which the player's piece stopped.

### CROSS-REFERENCE TO RELATED APPLICATIONS

This application claims benefit of priority based on Japanese Patent Application No. 2006-319092 filed on Nov. 27, 2006. The contents of this application are incorporated herein by reference in their entirety.

### BACKGROUND OF THE INVENTION

1. Field of the Invention

The present invention relates to a gaming apparatus such as a video poker machine, and a playing method of a card game such as poker.

2. Discussion of the Background

Conventionally there have been, as gaming machines, a slot machine in which a prize is offered when symbols are rearranged on a winning line (e.g. U.S. Pat. No. 6,093,102) and a slot machine in which a prize is offered in accordance with the number of symbols displayed to a display (e.g. U.S. Pat. No. 6,604,999). As a gaming machine other than these, for example, there has been a gaming machine of which a subject game is poker (e.g. UK Patent No. 2169737, U.S. Pat. No. 5,257,810, U.S. Pat. No. 5,390,934).

In the gaming machines as mentioned above, there are cases where a bonus game, namely, a game in which a returned profit becomes larger for the player, is generated, and during this bonus game, a second game may be executed subsequently to a normal game. There has also been proposed enabling the player to input an operation in this second game (e.g. U.S. Pat. No. 6,089,976).

The contents of U.S. Pat. No. 6,093,102, U.S. Pat. No. 6,604,999 and U.K. Patent No. 2,169,737, U.S. Pat. No. 5,257,810, U.S. Pat. No. 5,390,934, U.S. Pat. No. 6,089,976 are incorporated herein by reference in their entirety.

It is an object of the present invention to provide a new entertaining property, which has not been existent in the above-mentioned related arts. Specifically, an object of the present invention is to provide a gaming apparatus and a playing method of a card game, capable of varying a game result.

### SUMMARY OF THE INVENTION

In order to achieve the above-mentioned object, a first aspect of the present invention provides a gaming apparatus having a following structure.

(1) Namely, the gaming apparatus includes: a display capable of displaying a plurality of cards, a sugoroku (Japanese board game like “Snakes and Ladders”) board provided with a plurality of spaces, and a player's piece; an input switch capable of making an input of a hold and/or a change from the player; and a controller. The controller is programmed to conduct the processing of: (a) displaying the plurality of cards, the sugoroku board, and the player's piece to the display; (b) detecting the input of a hold and/or a change from the input switch; (c) exchanging a card in accordance with the detection; (d) moving the player's piece, when a combination of a plurality of cards after the exchange is a predetermined combination, on the sugoroku board by the number of spaces corresponding to the combination of the plurality of cards; and (e) providing an award corresponding to the space at which the player's piece stops.

According to the invention of (1), when a combination of a plurality of cards is a predetermined combination (e.g. Four of a kind in a poker game), the player's piece on the sugoroku board is moved by the number of spaces corresponding to the combination of the cards (e.g. the piece is moved by five spaces when Four of a kind is established with cards of the rank “5” in a poker game), and an award corresponding to a space at which the piece stopped is provided.

Therefore, when the combination of cards is different, it is highly possible that the number of spaces the piece moves is different. Accordingly, it is also highly possible that a stop position of the piece and the award to be provided are different. Further, even the number of spaces the piece moves is the same, the stop position of the piece is different when a start position of the piece is different. Accordingly, it is highly possible that the award to be provided is different. As thus described, by combining a card game and sugoroku, it is possible to vary a game result so as to provide a more entertaining game.

As a result, it becomes possible to provide an entertaining property which has not been existent in the related arts.

Further, a second aspect of the present invention provides a gaming apparatus having a following structure.

(2) Namely, the gaming apparatus includes: a display capable of displaying a plurality of cards, a sugoroku board provided with a plurality of spaces, and a player's piece; an input switch capable of making an input of a hold and/or a change from the player; and a controller. The controller is programmed to conduct the processing of: (a) displaying the plurality of cards, the sugoroku board, and the player's piece to the display; (b) detecting the input of a hold and/or a change from the input switch; (c) exchanging a card in accordance with the detection; (d) moving the player's piece, when a combination of a plurality of cards after the exchange is a predetermined combination, on the sugoroku board by the number of spaces corresponding to the combination of the plurality of cards; (e) executing a bonus game when the player's piece stops at a specific space; (f) determining a prize to be offered in the bonus game; and (g) offering the determined prize.

According to the invention of (2), when a combination of a plurality of cards is a predetermined combination, the player's piece on the sugoroku board is moved by the number of spaces corresponding to the combination of cards, and when the space at which the piece stopped is a specific space, a bonus game (e.g. free game, second game) is executed, and a prize determined in the bonus game is offered.

In the invention of (2), when the start position of the piece is different, it is highly possible that the combination of cards to be established by the player for acquiring a bonus game is different. Since the player needs to work out tactics in accordance with the start position of the piece for acquiring a bonus game, it is possible to vary the tactics for the game with the aim of acquiring the bonus game. Hence it is possible to increase amusement of attempting to acquire a bonus game, so as to provide a more entertaining game.

Further, since the move of the piece on the sugoroku board can be visually confirmed, it is possible to grasp a positional relation between a specific space corresponding to the bonus game and a space at which the piece stopped, so as to increase visual amusement.

Therefore, it is possible to provide an entertaining property which has not been existent in the related arts.

A third aspect of the present invention provides a gaming apparatus having a following structure.

(3) Namely, the gaming apparatus includes: a display capable of displaying a plurality of cards, a sugoroku board provided with a plurality of spaces, and a player's piece; an input switch capable of making an input of a hold and/or a change from the player; and a controller. The controller is programmed to conduct the processing of: (a) displaying a plurality of cards, the sugoroku board, and the player's piece to the display; (b) detecting the input of a hold and/or a change from the input switch; (c) exchanging a card in accordance with the detection; (d) moving the player's piece, when a combination of a plurality of cards after the exchange is a predetermined combination, on the sugoroku board by the number of spaces corresponding to the combination of the plurality of cards; (e) executing a bonus game in accordance with the combination of the plurality of cards when the player's piece stops at a specific space; (f) determining a prize to be offered in the bonus game; and (g) offering the determined prize.

According to the invention of (3), when a combination of a plurality of cards is a predetermined combination, the player's piece on the sugoroku board is moved by the number of spaces corresponding to the combination of cards, and when the space at which the piece stopped is a specific space, a bonus game in accordance with the combination of cards is executed, and a prize determined in the bonus game is offered.

In the invention of (3), when the start position of the piece is different, it is highly possible that the combination of cards to be established by the player for acquiring a bonus game is different. Since the player needs to work out tactics in accordance with the start position of the piece for acquiring a bonus game, it is possible to vary the tactics for the game with the aim of acquiring a bonus game. Hence it is possible to increase amusement of attempting to acquire a bonus game, so as to provide a more entertaining game.

Further, in the invention of (3), since a bonus game in accordance with an established combination of cards is executed, it is highly possible that an expectation for a player's target prize vary depending upon bonus games. When acquiring a bonus game in which the expectation for a player's target prize is high, the player inclines to acquire a bonus game of the same kind again. When acquiring a bonus game in which the expectation for a player's target prize is low, the player inclines to play a game again for acquiring a bonus game in which the expectation is higher. It is therefore possible to improve a willingness of the player to play a game again.

Moreover, since the move of the piece on the sugoroku board can be visually confirmed, it is possible to grasp a positional relation between a specific space corresponding to the bonus game and a space at which the piece stopped, so as to increase visual amusement.

Therefore, it is possible to provide an entertaining property which has not been existent in the related arts.

The first aspect of the present invention provides a playing method of a card game, including the following steps.

(4) Namely, the playing method of a card game includes the steps of: (a) dealing a plurality of cards; (b) exchanging a card in accordance with a hold and/or a change; (c) moving the player's piece, when a combination of a plurality of cards after the exchange is a predetermined combination, on the sugoroku board provided with a plurality of spaces by the number of spaces corresponding to the combination of the plurality of cards; and (d) providing an award corresponding to a space at which the player's piece stopped.

According to the invention of (4), when a combination of a plurality of cards is a predetermined combination, the player's piece on the sugoroku board is moved by the number of spaces corresponding to the combination of cards, and an award corresponding to the space at which the piece stopped is provided.

Therefore, when the combination of cards is different, it is highly possible that the number of spaces the piece moves is different. Accordingly, it is also highly possible that a stop position of the piece and the award to be provided are different. Further, even the number of spaces the piece moves is the same, the stop position of the piece is different when a start position of the piece is different. Accordingly, it is highly possible that the award to be provided is different. As thus described, by combining a card game and sugoroku, it is possible to vary a game result so as to provide a more entertaining game.

As a result, it is possible to provide an entertaining property which has not been existent in the related arts.

Further, the second aspect of the present invention provides a playing method of a card game, including the following steps.

(5) Namely, the playing method of a card game includes the steps of: (a) dealing a plurality of cards; (b) exchanging a card in accordance with a hold and/or a change; (c) moving the player's piece, when a combination of a plurality of cards after the exchange is a predetermined combination, on the sugoroku board provided with a plurality of spaces by the number of spaces corresponding to the combination of the plurality of cards; (d) executing a bonus game when the player's piece stops at a specific space; (e) determining a prize to be offered in the bonus game; and (f) offering the determined prize.

According to the invention of (5), when a combination of a plurality of cards is a predetermined combination, the player's piece on the sugoroku board is moved by the number of spaces corresponding to the combination of cards, and when the space at which the piece stopped is a specific space, a bonus game is executed, and a prize determined in the bonus game is offered.

In the invention of (5), when the start position of the piece is different, it is highly possible that the combination of cards to be established by the player for acquiring a bonus game is different t. Since the player needs to work out tactics in accordance with the start position of the piece for acquiring the bonus game, it is possible to vary the tactics for the game with the aim of acquiring the bonus game. Hence it is possible to increase amusement of attempting to acquire a bonus game, so as to provide a more entertaining game.

Further, since the move of the piece on the sugoroku board can be visually confirmed, it is possible to grasp a positional relation between a specific space corresponding to the bonus game and a space at which the piece stopped, so as to increase visual amusement.

Therefore, it is possible to provide an entertaining property which has not been existent in the related arts.

The third aspect of the present invention provides a playing method of a card game, including the following steps.

(6) Namely, the playing method of a card game includes the steps of: (a) dealing a plurality of cards; (b) exchanging a card in accordance with a hold and/or a change; (c) moving the player's piece, when a combination of a plurality of cards after the exchange is a predetermined combination, on the sugoroku board provided with a plurality of spaces by the number of spaces corresponding to the combination of the plurality of cards; (d) executing a bonus game in accordance with the combination of the plurality of cards when the player's piece stops at a specific space; (e) determining a prize to be offered in the bonus game; and (f) offering the determined prize.

According to the invention of (6), when a combination of a plurality of cards is a predetermined combination, the player's piece on the sugoroku board is moved by the number of spaces corresponding to the combination of cards, and when the space at which the piece stopped is a specific space, a bonus game in accordance with the combination of cards is executed, and a prize determined in the bonus game is offered.

In the invention of (6), when the start position of the piece is different, it is highly possible that the combination of cards to be established by the player for acquiring a bonus game is different. Since the player needs to work out tactics in accordance with the start position of the piece for acquiring a bonus game, it is possible to vary the tactics for the game with the aim of acquiring a bonus game. Hence it is possible to increase amusement of attempting to acquire a bonus game, so as to provide a more entertaining game.

Further, in the invention of (6), since a bonus game in accordance with an established combination of cards is executed, it is highly possible that an expectation for a player's target prize vary depending upon the bonus game. When acquiring a bonus game in which the expectation for a player's target prize is high, the player inclines to acquire a bonus game of the same kind again. When acquiring a bonus game in which the expectation for a player's target prize is low, the player inclines to play a game again for acquiring a bonus game in which the expectation is higher. It is therefore possible to improve a willingness of the player to play a game again.

Moreover, since the move of the piece on the sugoroku board can be visually confirmed, it is possible to grasp a positional relation between a specific space corresponding to a bonus game and a space at which the piece stopped, so as to increase visual amusement.

Therefore, it is possible to provide an entertaining property which has not been existent in the related arts.

According to the present invention, it is possible to provide an entertaining property which has not been existent in the foregoing related arts, namely, a gaming apparatus and a playing method of a card game which are capable of varying a game result.

### BRIEF DESCRIPTION OF THE DRAWINGS

FIG. 1 is a view showing one example of an image displayed to a lower image display panel.

FIG. 2 is a diagrammatic view showing an entire configuration of a game system according to one embodiment of the present invention.

FIG. 3 is a perspective view schematically showing a gaming apparatus according to one embodiment of the present invention.

FIG. 4 is a block diagram showing an internal configuration of the gaming apparatus shown in FIG. 3.

FIG. 5 is a block diagram showing an internal configuration of a server shown in FIG. 2.

FIG. 6 is a flowchart showing a subroutine of a game processing.

FIG. 7 is a flowchart showing a subroutine of a bonus game processing.

FIG. 8 is a view showing one example of images displayed to the lower image display panel when executing a bonus game.

FIG. 9 is a view showing one example of symbols displayed when executing a bonus game.

### DESCRIPTION OF THE EMBODIMENTS

The first aspect of the present invention is an invention in which an award corresponding to a space at which a piece stopped on a sugoroku board is provided. The second aspect of the present invention is an invention in which a bonus game is executed when the piece stops at a specific space on the sugoroku board. The third aspect of the present invention is the second aspect of the present invention in which a bonus game is a bonus game in accordance with a combination of cards. In the following description, the first, second, and third aspects of the present invention are simply referred to as the present invention when not particularly distinguished.

An Embodiment of the present invention will be described with reference to the drawings.

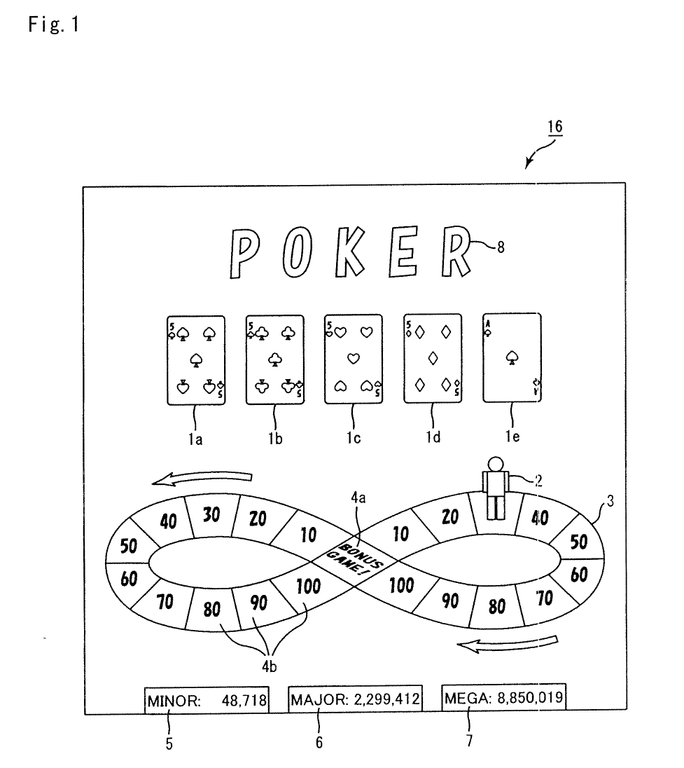

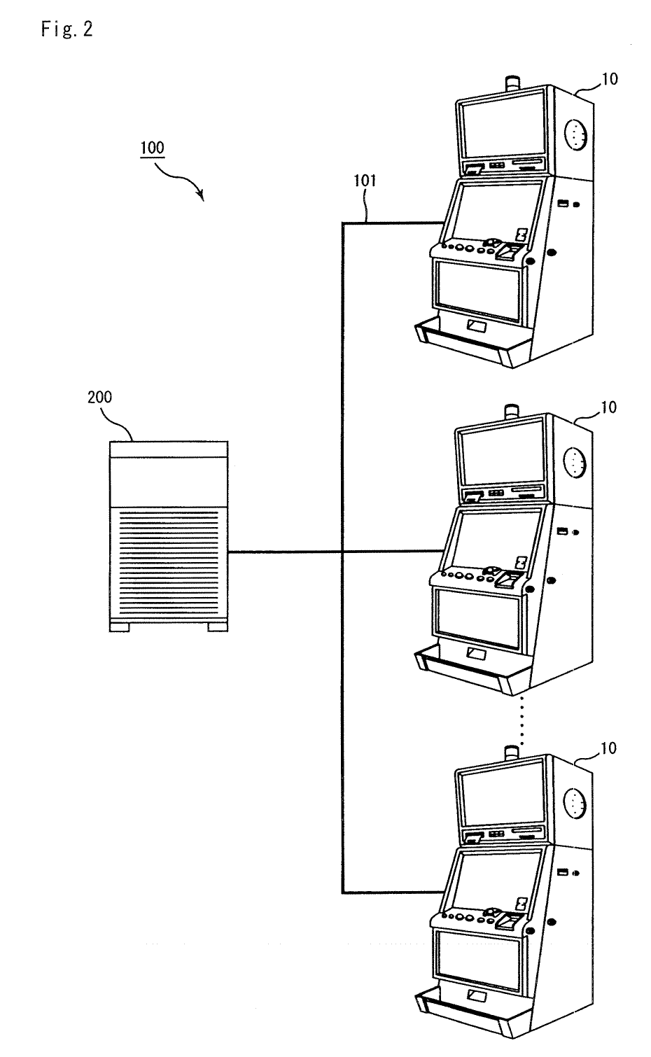

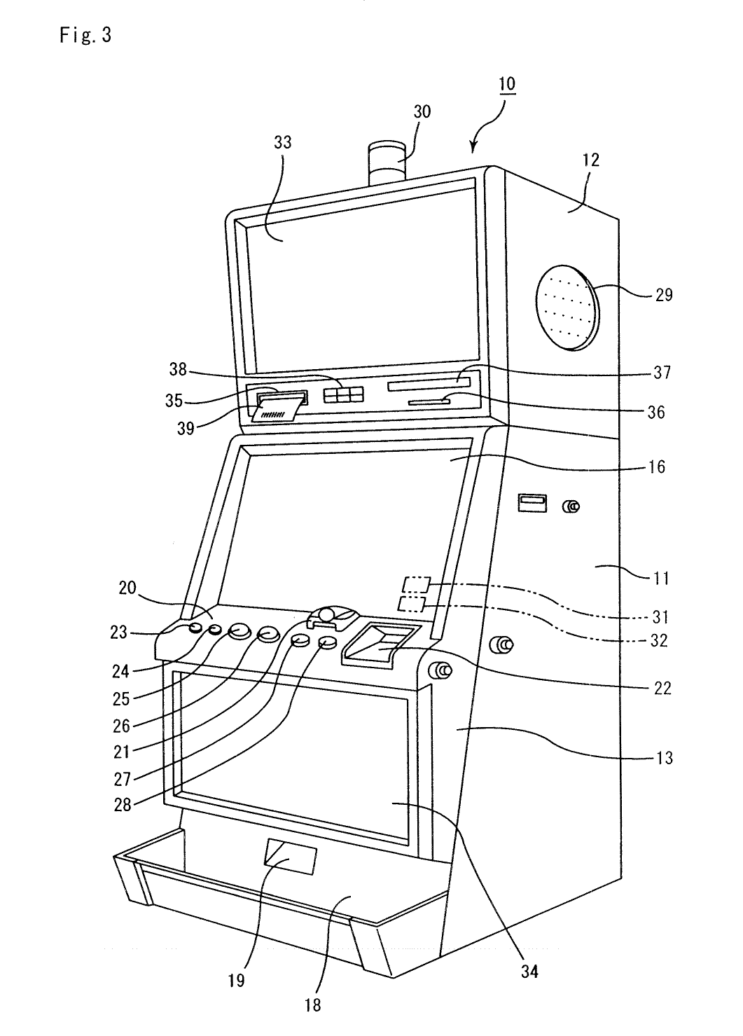

FIG. 1 is a view showing one example of an image displayed to a lower image display panel. FIG. 2 is a diagrammatic view showing an entire configuration of a game system according to one embodiment of the present invention. FIG. 3 is a perspective view schematically showing a gaming apparatus according to one embodiment of the present invention.

It is to be noted that, although a gaming apparatus 10 (see FIGS. 2 and 3) is a gaming apparatus connected to a server 200 (see FIG. 2) via a network, the present invention is also applicable to a standalone type gaming apparatus which is not connected to a network.

As shown in FIG. 1, at an upper portion of the lower image display panel 16 included in the gaming apparatus 10, there is displayed an image 8 showing “POKER”. Below the image 8, there are displayed five card images 1 (a card image 1a, a card image 1b, a card image 1c, a card image 1d, and a card image 1e in a direction from the left on the lower image display panel 16). Further, below the card images 1, there are displayed a piece 2 showing a player's piece and a sugoroku board 3 in a figure of “∞” (symbol indicating “endless”) formed by a plurality of spaces 4. The spaces 4 included in the sugoroku board 3 (a space at a central portion of “∞” is referred to as a space 4a, and spaces other than that are referred to as spaces 4b) are successively arranged such that each space 4 is adjacent to two spaces (adjacent to four spaces, as for the space 4a).

In each space 4, there is displayed an image of the number of credits to be paid out when the piece 2 stops or an image “BONUS GAME!” showing that a bonus game is executed when the piece 2 stops. Further, a start position of the piece 2 (space at which the piece 2 is displayed at the start of a game) is determined at random when a game is started.

The piece 2 moves on the sugoroku board 3 as described below. Namely, out of the two closed curves forming the figure of “∞”, the piece 2 moves counterclockwise along the left-side closed curve and clockwise along the right-side closed curve (see arrows in FIG. 1). Further, when reaching the space 4a (central portion of the figure of “∞”) after moving along one closed curve, the piece 2 then moves along the other closed curve.

In the gaming apparatus 10, five cards are displayed to play a poker game.

In the present embodiment, five cards to be displayed are selected among a set of playing cards except for a joker. Namely, five cards are selected among a total of 52 cards including thirteen kinds of numbers and alphabets, “A”, “2” to “10”, “J”, “Q”, and “K”, of each of the four suits (symbols printed on playing cards), spade, heart, diamonds, and club.

When the card images 1 are displayed, the player inputs a hold and a change with regard to the displayed five card images 1.

A hold means keeping a displayed card unchanged, and a change means exchanging a displayed card with another card. The card to which a change is inputted is exchanged with another card.

when Four of a kind is established after operations of a hold and a change, the piece 2 moves by the number of spaces 4 corresponding to a number or alphabet on the card images 1 forming Four of a kind, and credits corresponding to the space 4 at which the piece 2 stopped are paid out.

Four of a kind is established when a player has four cards having the same number or alphabet printed thereon. In the present embodiment, the number of spaces 4 that the piece 2 moves in the case of establishment of Four of a kind is one when Four of a kind is established by cards with “A” printed thereon (hereinafter, a case where Four of a kind is established by cards with “X” printed thereon is referred to as the case of Four of a kind of “X”), the number of spaces 4 is two in the case of Four of a kind of “2”, . . . ten in the case of Four of a kind of “10”, and ten in the cases of Four of a kind of “J” to “K”. For example, in FIG. 1, the card image 1a is “5” of Spade, the card image 1b is “5” of Club, the card image 1c is “5” of Heart, and the card image 1d is “5” of Diamond. Therefore, Four of a kind of “5” has been established. In this case, the piece 2 moves by five spaces from the position shown in FIG. 1 in a direction of the arrows, and stops at the space 4 with “80” displayed thereon. Consequently, 80 credits are paid out as an award.

It is to be noted that the number of spaces that the piece 2 moves in the case of establishment of Four of a kind is not limited to the foregoing example, but may be set as appropriate.

When the piece 2 stops at the space 4 corresponding to a bonus game, namely, the space 4 with “BONUS GAME!” displayed thereon, free games (games that can be played without inserting another currency value) are played as bonus games for the same number of times as the number of spaces that the piece 2 moved.

In this bonus game, a jackpot (hereinafter also referred to as JP) is set as a prize, and when a JP is won, credits corresponding to the JP are paid out.

In the present embodiment, three kinds of JPs, “MINOR”, “MAJOR”, and “MEGA”, are set as described later. These JPs are progressive jackpots, and part of credits bet by the player is cumulatively stored as credits for each JP. Current amounts of the respective JPs are displayed to a MINOR display section 5, a MAJOR display section 6, and a MEGA display section 7 shown on the lower side of FIG. 1.

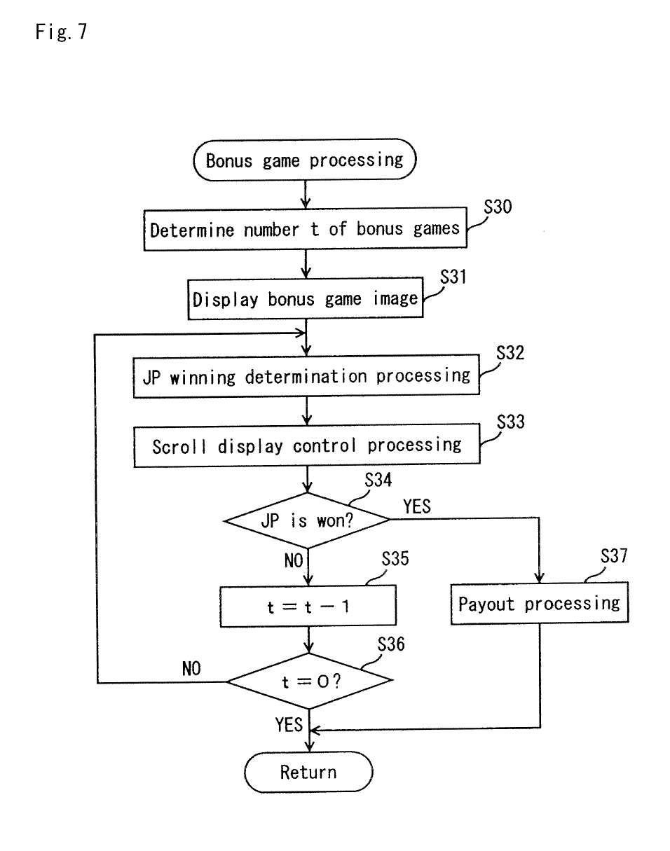

A specific description of the bonus game will be given later with reference to FIGS. 7, 8, and 9.

In the present embodiment, the piece 2 is moved in the case of establishment of the hand “Four of a kind” in a poker game. However, a condition for moving the piece is not limited to this example. For example, the piece may be moved in the case of establishment of the hand “Two pair” in a poker game, or the piece may be moved in the case of establishment of the hand “Three of a kind” in a poker game.

Further, in the present embodiment, the number of spaces that the piece 2 moves corresponds to a number or alphabet printed on cards forming the established hand (Four of a kind). However, a relation between the combination of cards and the number of spaces that a piece moves is not limited to this example. For example, the number of spaces that the piece moves may correspond to the established hand such that the piece moves by one space in the case of establishment of the hand “One pair” and the piece moves by two spaces in the case of establishment of the hand “Two pair”.

Furthermore, five cards are to be selected out of 52 cards and then displayed in the present embodiment. However, the number of cards from which cards are to be selected is not limited to 52 in the present invention.

Moreover, five cards are displayed to play a poker game in the present embodiment. However, the number of cards to be displayed is not limited to 5 in the present invention, and may also be 4 or less, or 6 or more.

Although there is described a case where a card game is a poker game in the present embodiment, the card game is not particularly limited in the present invention so long as it is a game in which a combination of cards can be formed.

Although there is described a case where playing cards are used as cards in the present embodiment, cards used in a cardgame are not limited to playing cards in the present invention. For example, tarot cards may be used.

Further, in the present invention, the sugoroku board refers to a series of a plurality of spaces along which a piece moves following a certain rule. The sugoroku board in the present invention includes one in which moving paths of the piece form an intersection or a branch configuration. Moreover, the sugoroku board in the present invention includes one in which a “Start” space at which a piece is placed at the start of the game and a “Goal” space at which the piece arrives to finish the game are set, and one in which a “Start” space and a “Goal” space are not set like the sugoroku board 3 of the present embodiment.

Although the sugoroku board in the figure of “∞” is displayed in the present embodiment, the shape of the sugoroku board is not limited to the figure of “∞” in the present invention. Examples thereof may include a quadrangle, a figure of S, and a straight line.

Although the spaces 4 are displayed to the lower image display panel 16 in the present embodiment so that the spaces 4 on the sugoroku board 3 are visible to the player, spaces may not be displayed but only a moving path of the piece may be displayed.

Further, in the present embodiment, when the piece 2 stops at a single space 4, credits corresponding to that space 4 are paid out. However, the piece may be moved on a sugoroku board provided with no spaces, along a predetermined moving path in accordance with a combination of cards, and when a total moving amount of the piece exceeds a predetermined amount, an award may be provided in accordance with the moving amount.

Moreover, in the present invention, an award corresponding to each space is not limited to the example shown in FIG. 1, but may be set as appropriate.

Next, there will be described a game system according to the present embodiment.

As shown in FIG. 2, a game system 100 includes a plurality of gaming apparatus 10 and the server 200 connected to these gaming apparatus 10 via a predetermined communication line 101. Such a game system 100 may be constructed inside one recreation facility where a variety of games can be played, such as a bar or a casino, or constructed among a plurality of recreation facilities. Further, in the case of constructing the game system 100 inside one recreation facility, the game system 100 may be constructed on each floor or in each section of the recreation facility. The communication line 101 is not particularly limited, and may be either wired or wireless, and an exclusive line, an exchange line or the like may be adopted.

The server 200 cumulatively stores part of credits corresponding to coins bet at each gaming apparatus 10. The server 200 receives information on credits corresponding to bet coins (hereinafter also referred to as bet information) from each gaming apparatus 10 via the communication line 101, and distributes part of the bet credits to store as credits for three kinds of JPs: “MINOR”, “MAJOR”, and “MEGA”.

Although credits for JP are stored in the server 200 in the present embodiment, credits for JP may be stored in the gaming apparatus.

Next, there will be described the gaming apparatus according to the present embodiment with reference to FIG. 3.

In the gaming apparatus 10, a coin, a bill, or electronic valuable information corresponding to these is used as a currency value. However, in the present invention, the currency value is not particularly limited. Examples thereof may include a medal, a token, electronic money, and a ticket. It is to be noted that the ticket is not particularly limited, and examples thereof may include a ticket with a barcode as described later.

The gaming apparatus 10 includes a cabinet 11, a top box 12 installed on the upper side of the cabinet 11, and a main door 13 provided at the front face of the cabinet 11.

The lower image display panel 16 is provided at the front of the main door 13. The lower image display panel 16 is provided with a transparent liquid crystal panel to which five card images 1 (1a, 1b, 1c, 1d, 1e) and a sugoroku board 3 are displayed. The lower image display panel 16 corresponds to the display in the present invention.

A number-of-credits display section 31 and a number-of-payouts display section 32 are provided in the lower image display panel 16. To the number-of-credits display section 31, the number of credited coins is displayed using an image. To the number-of payouts display section 32, the number of coins to be paid out is displayed using an image.

Moreover, although not shown, a touch panel 69 is provided at the front face of the lower image display panel 16, and the player can operate the touch panel 69 to input a variety of commands.

Below the lower image display panel 16, there are provided a control panel 20 including a plurality of buttons 23 to 28 with each of which a command according to the game progress is inputted by the player, a coin receiving slot 21 for accepting a coin into the cabinet 11, and a bill validator 22.

The control panel 20 is provided with an exchange button 23, a CASHOUT button 24, a 1-BET button 25, a maximum BET button 26, a hold button 27, and a change button 28. The exchange button 23 is used in making a request of a staff in the recreation facility for exchange. The CASHOUT button 24 is used for inputting a command to pay out credited coins to a coin tray 18.

The 1-BET button 25 is used for inputting a command to bet one coin on a game, out of the credited coins. The maximum BET button 26 is used for inputting a command to bet the maximum number of coins (fifty coins in the present embodiment) that can be bet on one game, out of the credited coins.

The hold button 27 is a button used for inputting a command to hold a displayed card, and the change button 28 is a button used for inputting a command to change a displayed card. The hold button 27 and the change button 28 correspond to the input switch in the present invention.

Although commands for a hold and a change are inputted by operating the hold button 27 and the change button 28 in the present embodiment, inputting method is not limited to this example in the present invention, and for example, the touch panel may be operated to input commands for a hold and a change.

The bill validator 22 not only discriminates a regular bill from a false bill, but also accepts the regular bill into the cabinet 11. It is to be noted that the bill validator 22 may be configured to be capable of reading a later-described ticket 39 with a barcode. At the lower front of the main door 13, namely, below the control panel 20, a belly glass on which a character or the like of the gaming apparatus 10 is drawn 34 is provided.

The upper image display panel 33 is provided on a front surface of the top box 12. The upper image display panel 33 is provided with a liquid crystal panel to display, for example, an image representing introduction of the contents of the game and explanation of a rule of the game.

Further, a speaker 29 is provided in the top box 12. Under the upper image display panel 33, there are provided a ticket printer 35, a card reader 36, a data display 37 and a keypad 38. The ticket printer 35 prints on a ticket a barcode as coded data of the number of credits, a date, an identification number of the gaming apparatus 10 and the like, and outputs a ticket as the ticket 39 with a barcode. The player can have another gaming apparatus read the ticket 39 with a barcode to play a game thereon, or exchange the ticket 39 with a barcode with a bill or the like at a predetermined place in a recreation facility (for example, a cashier in a casino).

The card reader 36 reads data from a smart card and write data into the smart card. The smart card is a card to be carried by a player, and stores, for example, data to identify the player and data on the history of the game played by the player. The smart card may store data corresponding to the coin, the bill, or the credit. Further, a magnetic stripe card may be employed in place of the smart card. The data display 37 includes a fluorescent display and the like, and displays, for example, data read through the card reader 36 or data inputted by the player via the keypad 38. The keypad 38 is used for inputting a command and data to issue a ticket and the like.

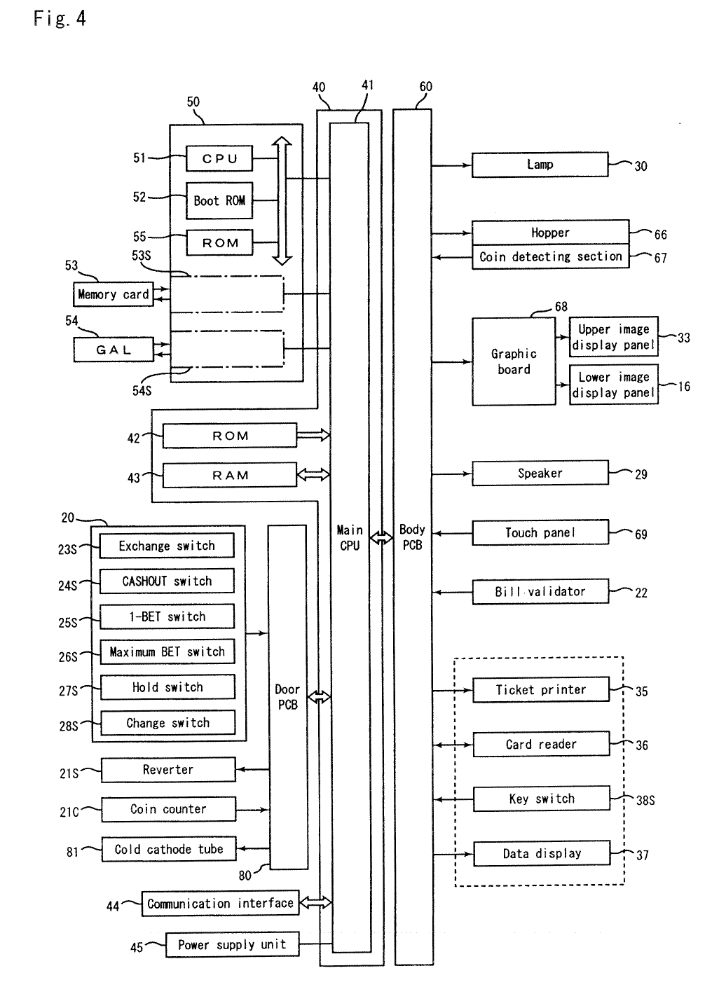

FIG. 4 is a block diagram showing an internal configuration of the gaming apparatus shown in FIG. 3.

A gaming board 50 is provided with: a CPU (Central Processing Unit) 51, a ROM 55, and a boot ROM 52 which are interconnected to one another by an internal bus; a card slot 53S corresponding to a memory card 53; and an IC socket 54S corresponding to a GAL (Generic Array Logic) 54.

The memory card 53 includes a nonvolatile memory such as CompactFlash (registered trademark) or the like, and stores a game program.

Further, the card slot 53S is configured to allow the memory card 53 to be inserted thereinto and ejected therefrom, and is connected to a motherboard 40 through an IDE bus. Therefore, the types and contents of games played in the gaming apparatus 10 can be changed by ejecting the memory card 53 from the card slot 53S, then writing another game program into the memory card 53 and then inserting the memory card 53 into the card slot 53S. The game program includes a program relating to progression of the game. Further, the game program includes image data and sound data to be outputted during the game.

The CPU 51, the ROM 55, and the boot ROM 52 interconnected to one another by the internal bus are connected to the motherboard 40 through the PCI bus. The PCI bus not only conducts signal transmission between the motherboard 40 and the gaming board 50, but also supplies electric power from the motherboard 40 to the gaming board 50.

The motherboard 40 is configured by using a commercially available general-purpose motherboard (a printed wiring board on which fundamental components of a personal computer are mounted), and includes a main CPU 41, a ROM (Read Only Memory) 42, a RAM (Random Access Memory) 43, and a communication interface 44. The motherboard 40 corresponds to the controller in the present invention.

The ROM 42 includes a memory device such as a flash memory, and stores a program such as BIOS (Basic Input/Output System) executed by the main CPU 41 and permanent data. When the BIOS is executed by the main CPU 41, processing for initializing a predetermined peripheral device is conducted, concurrently with start of processing for loading the game program stored in the memory card 53 via the gaming board 50. It is to be noted that in the present invention, the ROM 42 may or may not be data rewritable one.

The RAM 43 stores data and a program to be used at the time of operation of the main CPU 41. Further, the RAM 43 is capable of storing a game program. Moreover, the RAM 43 stores data of the number of credits, the number of coin-ins and coin-outs in a single game, and the like.

Furthermore, the motherboard 40 is connected with a later-described body PCB (Printed Circuit Board) 60 and a door PCB 80 through respective USBs. Further, the motherboard 40 is connected with the communication interface 44 and a power supply unit 45.

The body PCB 60 and the door PCB 80 are connected with an equipment and a device, which generate an input signal to be inputted into the main CPU 41, and with an equipment and a device, operations of which are controlled by a control signal outputted from the main CPU 41. The main CPU 41 executes the game program stored in the RAM 43 based on the input signal inputted into the main CPU 41, and thereby conducts the predetermined arithmetic processing and stores the result thereof into the RAM 43, or transmits a control signal to each equipment and device as a processing for controlling each equipment and device.

The body PCB 60 is connected with a lamp 30, a hopper 66, a coin detecting section 67, a graphic board 68, a speaker 29, a touch panel 69, a bill validator 22, a ticket printer 35, a card reader 36, a key switch 38S, and a data display 37. The lamp 30 is lighted in a predetermined pattern based on a control signal outputted from the main CPU 41.

The hopper 66 is installed inside the cabinet 11, and pays out coins in predetermined number from a coin payout exit 19 onto the coin tray 18 based on the control signal outputted from the main CPU 41. The coin detecting section 67 is provided inside the coin payout exit 19, and outputs an input signal to the main CPU 41 when detecting payout of coins in predetermined number from the coin payout exit 19.

The graphic board 68 controls image display to the upper image display panel 33 and the lower image display panel 16 based on the control signal outputted from the main CPU 41. The number-of-credits display section 31 of the lower image display panel 16 displays the number of credits stored in the RAM 43. Further, the number-of-payouts display section 32 of the lower image display panel 16 displays the number of coin-outs. The graphic board 68 includes a VDP (Video Display Processor) for generating image data based on the control signal outputted from the main CPU 41, a video RAM for temporarily storing image data generated by the VDP, and the like. It is to be noted that image data used in generating the image data by the VDP is included in the game program, which is read from the memory card 53 and stored in the RAM 43.

The bill validator 22 not only discriminates a regular bill from a false bill, but also accepts the regular bill into the cabinet 11. Upon acceptance of the regular bill, the bill validator 22 outputs an input signal to the main CPU 41 based on the amount of the bill. The main CPU 41 stores in the RAM 43 the number of credits in accordance with the amount of the bill transmitted by the input signal.

The ticket printer 35, based on the control signal outputted from the main CPU 41, prints on a ticket a barcode as coded data of the number of credits stored in the RAM 43, a date, an identification number of the gaming apparatus 10 and the like, and outputs the ticket as the ticket 39 with a barcode.

The card reader 36 reads data from the smart card and transmits the data to the main CPU 41, and also writes data into the smart card based on the control signal from the main CPU 41. The key switch 38S is provided on the keypad 38, and outputs a predetermined input signal to the main CPU 41 when the keypad 38 is operated by the player. The data display 37, based on the control signal outputted from the main CPU 41, displays data read by the card reader 36 and data inputted by the player via the keypad 38.

The door PCB 80 is connected with the control panel 20, a reverter 21S, a coin counter 21C, and a cold-cathode tube 81. The control panel 20 is provided with an exchange switch 23S corresponding to the exchange button 23, a CASHOUT switch 24S corresponding to the CASHOUT button 24, a 1-BET switch 25S corresponding to the 1-BET button 25, a maximum BET switch 26S corresponding to the maximum BET button 26, a hold switch 27S corresponding to the hold button 27, and a change switch 28S corresponding to the change button 28. Each of the switches 23S to 28S outputs an input signal to the main CPU 41 when each of the buttons 23 to 28 corresponding thereto is operated by the player.

The coin counter 21C is provided inside the coin receiving slot 21, and discriminates a regular coin from a false coin inserted by the player into the coin receiving slot 21. A coin other than the regular coin is discharged from the coin payout exit 19. Further, the coin counter 21C outputs an input signal to the main CPU 41 when detecting the regular coin.

The reverter 21S operates based on the control signal outputted from the main CPU 41, and distributes coins recognized as the regular coin by the coin counter 21C into a cash box (not shown) installed inside the gaming apparatus 10 or the hopper 66. Namely, when the hopper 66 is filled with coins, the regular coin is distributed by the reverter 21S into the cash box. On the other hand, when the hopper 66 is not filled with coins, the regular coin is distributed to the hopper 66. The cold cathode tube 81 functions as a back light installed on the rear face sides of the lower image display panel 16 and the upper image display panel 33, and is lighted based on the control signal outputted from the main CPU 41.

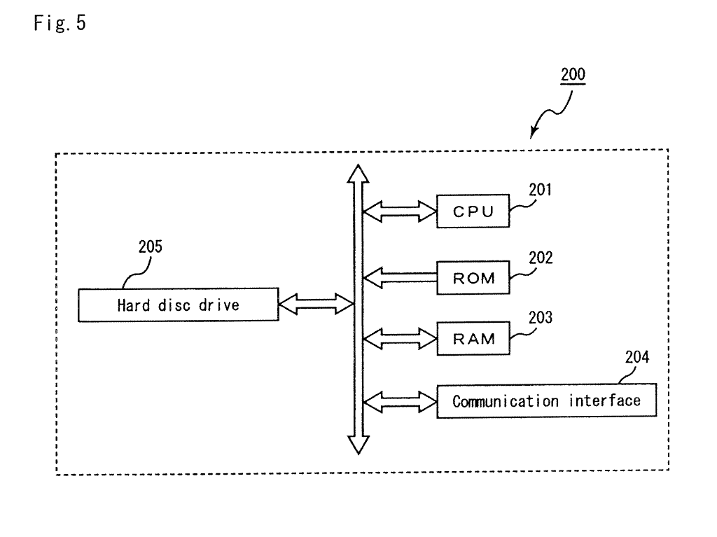

FIG. 5 is a block diagram showing an internal configuration of the server shown in FIG. 2.

The server 200 includes a CPU 201, a ROM 202, a RAM 203, a communication interface 204, and a hard disc drive 205 as a memory. The communication interface 204 is connected with the communication interface 44 of each gaming apparatus 10 via the communication line 101. The ROM 202 stores a system program for controlling the operation of the server 200 and permanent data. Further, the RAM 203 temporarily stores data received from each gaming apparatus 10, arithmetic result, and the like. The hard disc drive 205 stores credits for three kinds of JP: “MINOR”, “MAJOR”, and “MEGA”.

Next, there will be described a processing executed in the gaming apparatus 10.

The main CPU 41 reads and executes a game program to advance a game.

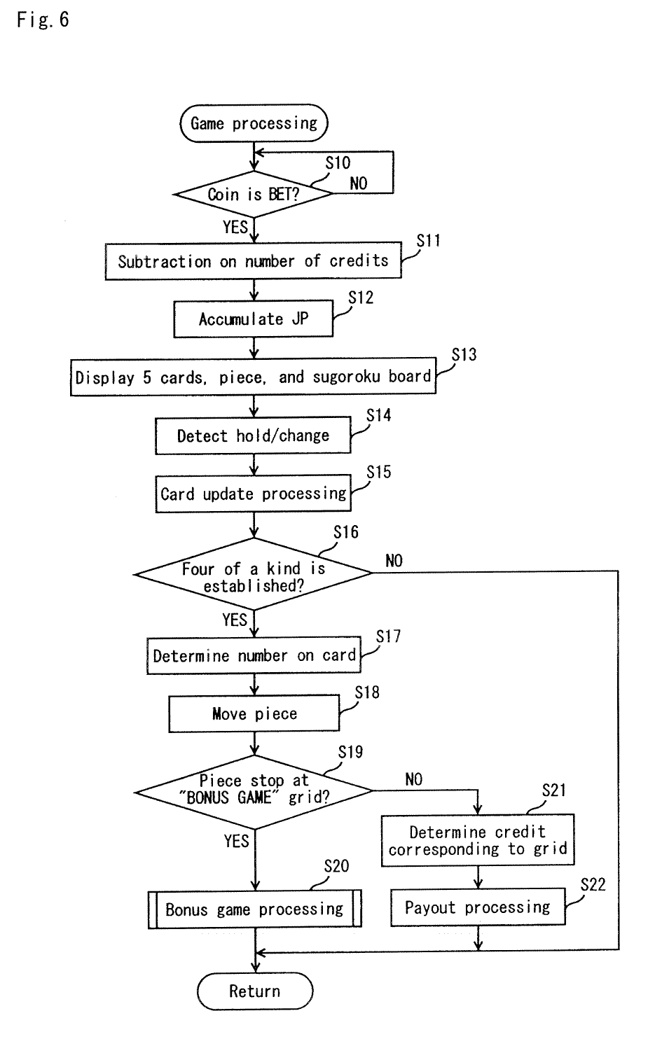

FIG. 6 is a flowchart showing a subroutine of a game processing. First, in Step S10, the main CPU 41 determines whether or not a coin is bet. In this processing, the main CPU 41 determines whether or not to have received an input signal which is to be outputted from the 1-BET switch 25S when the 1-BET button 25 is operated, or an input signal which is to be outputted from the maximum BET switch 26S when the maximum BET button 26 is operated. When determining that no coin is bet, the main CPU 41 returns the processing to Step S10.

On the other hand, when determining that the coin is bet, the main CPU 41 conducts processing of subtraction on the number of credits stored in the RAM 43 in accordance with the number of bet coins (Step S11). It is to be noted that, when the number of bet coins is larger than the number of credits stored in the RAM 43, the main CPU 41 returns the processing to step S10, without conducting the processing of subtraction on the number of credits stored in the RAM 43. Further, when the number of bet coins exceeds an upper limit value (50 coins in the present embodiment) that can be bet on one game, the main CPU 41 shifts the processing to step S12, without conducting the processing of subtraction on the number of credits stored in the RAM 43.

Next, in Step S12, the main CPU 41 conducts processing of cumulatively accumulating credits for JPs.

More specifically, the main CPU 41 transmits bet information to the server 200. On receiving the bet information, the server 200 cumulatively accumulates credits corresponding to 0.3% of the bet credits to credits for JP of “MINOR”, credits corresponding to 0.2% of the bet credits to credits for JP of “MAJOR”, and credits corresponding to 0.15% of the bet credits to credits for JP of “MEGA”, each stored in the hard disc drive 205.

Next, in Step S13, the main CPU 41 determines types of the card images 1 to be displayed and a start position of the piece 2 on the sugoroku board 3 by using random numbers, and displays the five card images 1, the piece 2, and the sugoroku board 3 to the lower image display panel 16.

When the card images 1, the piece 2, and the sugoroku board 3 are already on display after a game or for some other reasons, card images and the start position of the piece are updated to newly determined ones.

In the present embodiment, the start position of the piece 2 is updated every time a new game is played. However, in the present invention, for example, a space at which the piece stopped in a previous game may be set as the start position of the piece. In that case, the start position of the piece at the activation of the gaming apparatus may be previously determined, or may be determined by using a random number. Further, for example, the start position of the piece may be the same in each game.

Next, the main CPU 41 detects an input of a hold and/or a change by the player (Step S14), and subsequently conducts processing of updating the card images 1 (Step S15).

Specifically, first, the card image 1a flashes to instruct the player to press the hold button 27 or the change button 28. When detecting an input of a hold, the main CPU 41 keeps the card image 1a unchanged. When detecting an input of a change, the main CPU 41 changes the card image 1a to another card image determined by using a random number. Subsequently, the same processing is repeated with regard to the other card images in the order of the card image 1b, the card image 1c, the card image 1d, and the card image 1e.

Next, in Step S16, the main CPU 41 determines whether or not Four of a kind has been established by the five card images 1. Namely, the main CPU 41 determines whether or not there are four card images with the same number or alphabet printed thereon.

When determining that Four of a kind is not established, the main CPU 41 terminates the present subroutine.

On the other hand, when determining that Four of a kind is established, the main CPU 41 determines which number or alphabet is printed on the card images 1 forming Four of a kind.

Next, in Step S18, the main CPU 41 moves the piece 2 on the sugoroku board 3 based on the number or alphabet determined in Step S17. A corresponding relation between the number or alphabet printed on the card images 1 forming Four of a kind and the number of spaces that the piece 2 moves has already been described, and the description thereof will not be repeated here.

In the present embodiment, a moving direction of the piece 2 is preliminary determined. However, in the present invention, the moving direction of the piece may be determined in each game.

Next, in Step S19, the main CPU 41 determines whether or not the piece 2 has stopped at a space corresponding to a bonus game (space 4a).

When determining that the piece 2 has not stopped at the space corresponding to a bonus game, the main CPU 41 determines credits corresponding to the space 4 at which the piece 2 has stopped in Step S21.

Next, in Step S22, the main CPU 41 pays out credits determined in Step S21.

When determining in Step S19 that the piece 2 has stopped at the space corresponding to a bonus game, the main CPU 41 conducts a bonus game processing in Step S20. This processing will be specifically described later with reference to FIGS. 7, 8, and 9.

After conducting the processing of Step S20 or Step S22, the main CPU 41 terminates the present subroutine.

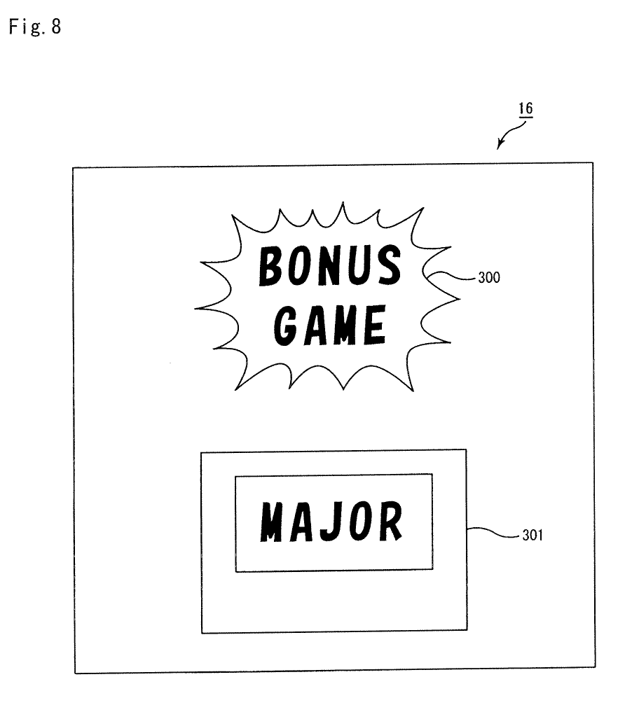

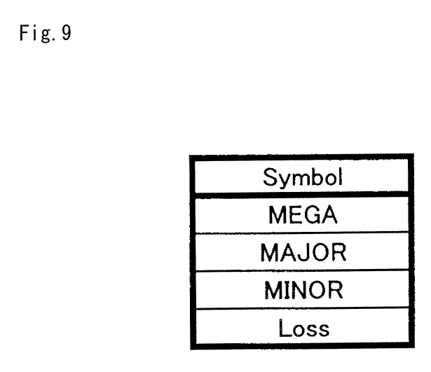

FIG. 7 is a flowchart showing a subroutine of a bonus game processing which is conducted in Step S20 of FIG. 6. FIG. 8 is a view showing one example of images displayed to the lower image display panel when executing a bonus game. FIG. 9 is a view showing one example of symbols displayed when executing a bonus game.

In the bonus game processing, first, in Step S30, the main CPU 41 determines the number t of the bonus game based on the number or alphabet determined in Step S17 of FIG. 6. In the present embodiment, the number t of the bonus game is the same as the number of spaces that the piece 2 moves.

The determined value t is stored in the RAM 43.

Next, in Step S31, the main CPU 41 displays an image 300 representing “BONUS GAME” and a symbol display section 301 to the lower image display panel 16. To the symbol display section 301, four kinds of symbols shown in FIG. 9, namely, “MEGA”, “MAJOR”, “MINOR”, and “LOSS” are scroll-displayed, and stop-displayed after the lapse of a predetermined time. A symbol displayed at this time represents a winning JP (or loss).

Next, in Step S32, the main CPU 41 conducts a JP winning determination processing. Namely, the main CPU 41 determines whether or not a JP will be won, and when determining that a JP will be won, the main CPU 41 determines which JP will be won among “MEGA”, “MAJOR”, and “MINOR”.

In the present embodiment, determining winning of a JP or losing corresponds to offering a prize in the present invention.

Next, in Step S33, the main CPU 41 conducts a scroll display control processing for symbols in the symbol display section 301. This processing is a processing of starting scroll display of four kinds of symbols shown in FIG. 9, and after the lapse of a predetermined time, stop-displaying a symbol corresponding to a winning JP or loss determined in Step S32.

Next, in Step S34, the main CPU 41 determines whether or not the JP has been won based on a determination in Step S32.

When determining that the JP has been won, in Step S37, the main CPU 41 pays out credits corresponding to the winning JP.

On the other hand, when determining in Step S34 that the JP has not been won, in Step S35, the main CPU 41 conducts a processing of subtracting one from the value of t.

Next, in Step S36, the main CPU 41 determines whether or not the value of t is zero. Namely, the main CPU 41 determines whether or not bonus games in the determined number have been completed.

When determining that the value of t is not zero, the main CPU 41 returns the processing to Step S32.

When determining in Step S36 that the value of t is zero, or after conducting the processing of Step S37, the main CPU 41 terminates the present subroutine.

As thus described, the gaming apparatus 10 according to the present embodiment includes the lower image display panel 16 (display) capable of displaying five cards, the sugoroku board 3 provided with a plurality of spaces 4, and the piece 2. Further, the gaming apparatus 10 includes the hold button 27 (input switch) capable of making an input of a hold from the player, and the change button 28 (input switch) capable of making an input of a change from the player. Moreover, the gaming apparatus 10 includes the motherboard 40 (controller) programmed to conduct the following processing of: (a) displaying the five cards, the sugoroku board 3, and the piece 2 to the lower image display panel 16; (b) detecting the input of a hold and/or a change from the hold button 27 and/or the change button 28; (c) exchanging a card in accordance with the detection; (d) moving the piece 2, when a combination of the cards after the exchange is Four of a kind, on the sugoroku board 3 by the number of spaces corresponding to a number or alphabet printed on cards forming Four of a kind; (e) executing a bonus game in accordance with the number or alphabet printed on cards forming Four of a kind, when the piece 2 stops at a specific space; (f) determining whether or not a JP will be won, and when determining that a JP will be won, determining which JP will be won among “MEGA”, “MAJOR”, and “MINOR”; and (g) paying out credits corresponding to the JP determined as the winning JP.

Although free games are played as bonus games in the same number as the number of spaces that the piece 2 moves (free games in number corresponding to a number or alphabet printed on cards forming Four of a kind) in the present embodiment, the bonus game in the present invention is not particularly limited, so long as the game is played in accordance with a combination of cards established in a card game.

“A bonus game corresponding to a combination of cards” refers to one kind of bonus game determined by determination of a combination of cards, and includes a bonus game in one-to-one correspondence with a combination of cards and a bonus game determined by predetermined calculation based on a combination of cards.

Examples of the bonus game of this kind may include, in addition to a game in which free games are played in number determined based on a combination of cards as shown in the present embodiment, a game in which a winning probability for a JP is set in accordance with the combination of cards and a game in which time, sound, and images are varied in accordance with the combination of cards.

A Content of the bonus game in the present invention is not particularly limited so long as a prize is offered (e.g. payout of currency value), and examples thereof may include a card game, a slot game, and a roulette game.

The bonus game as thus described may or may not be advanced by an input of an operation from the player.

In the present embodiment, three kinds of JPs “MEGA”, “MAJOR”, and “MINOR” are provided. However, there may be provided JPs in four kinds or more, or in two kinds or less in the present invention.

Further, the ratio of credits cumulatively accumulated as credits for each JP to the total bet credits is not limited to the value shown in the present embodiment, but may be set as appropriate.

Although the case was described in the present embodiment where the prize in the bonus game is any of three kinds of JPs and a loss, the prize in the present invention is not limited to this example. For example, predetermined credits may be set as a prize.

Although the case was described in the present embodiment where only a single space is set as the specific space in the present invention, two or more spaces may be set as the specific spaces in the present invention.

Further, in the present invention, the position of the specific space is not limited to the example shown in the present embodiment, but may be set as appropriate.

Furthermore, in the present embodiment, a bonus game is played when the piece 2 stops at the specific space. However, in the first aspect of the present invention, not limited to this example, a specific space may be set, for example, as a space corresponding to a JP and credits for the JP may be paid out when the piece stops at the specific space.

Moreover, in the first aspect of the present invention, a specific space may not be provided.

Although the case was described in the present embodiment where the gaming apparatus 10 is used to execute a card game (poker game), the present invention is not limited to this example. For example, a card game may be played by a plurality of players without using a gaming apparatus. In this case, a playing method of a card game may be adopted, which includes the following steps of: (a) dealing a plurality of cards to each player; (b) exchanging each player's card in accordance with a hold and/or a change; (c) moving the player's piece, when a combination of a plurality of cards after the exchange is a predetermined combination, on a sugoroku board provided with a plurality of spaces by the number of spaces corresponding to the combination of the plurality of cards; (d) executing a bonus game in accordance with the combination of the plurality of cards when the player's piece stops at a specific space; (e) determining a prize to be offered in the bonus game; and (f) offering the determined prize.

Although the embodiments of the present invention have been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processes to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming apparatus comprising:
a display capable of displaying a plurality of cards, a sugoroku (Japanese board game like “Snakes and Ladders”) board provided with a plurality of spaces, and a player's piece;
an input switch capable of making an input of a hold and/or a change from the player; and
a controller,
said controller programmed to conduct the processing of:
(a) displaying said plurality of cards, said sugoroku board, and said player's piece to said display;
(b) detecting the input of a hold and/or a change from said input switch;
(c) exchanging a card in accordance with the detection;
(d) moving said player's piece, when a combination of a plurality of cards after the exchange is a predetermined combination, on said sugoroku board by the number of spaces corresponding to the combination of said plurality of cards; and
(e) providing an award corresponding to said space at which said player's piece stopped.

2. A gaming apparatus comprising:
a display capable of displaying a plurality of cards, a sugoroku board provided with a plurality of spaces, and a player's piece;
an input switch capable of making an input of a hold and/or a change from the player; and
a controller,
said controller programmed to conduct the processing of:
(a) displaying said plurality of cards, said sugoroku board, and said player's piece to said display;
(b) detecting the input of a hold and/or a change from said input switch;
(c) exchanging a card in accordance with the detection;
(d) moving said player's piece, when a combination of a plurality of cards after the exchange is a predetermined combination, on said sugoroku board by the number of spaces corresponding to the combination of said plurality of cards;
(e) executing a bonus game when said player's piece stops at a specific space;
(f) determining a prize to be offered in said bonus game; and
(g) offering the determined prize.

3. A gaming apparatus comprising:
a display capable of displaying a plurality of cards, a sugoroku board provided with a plurality of spaces, and a player's piece;
an input switch capable of making an input of a hold and/or a change from the player; and
a controller,
said controller programmed to conduct the processing of:
(a) displaying a plurality of cards, said sugoroku board, and said player's piece to said display;
(b) detecting the input of a hold and/or a change from said input switch;
(c) exchanging a card in accordance with the detection;
(d) moving said player's piece, when a combination of a plurality of cards after the exchange is a predetermined combination, on said sugoroku board by the number of spaces corresponding to the combination of said plurality of cards;
(e) executing a bonus game in accordance with the combination of said plurality of cards when said player's piece stops at a specific space;
(f) determining a prize to be offered in said bonus game; and
(g) offering the determined prize.

4. A playing method of a card game comprising the steps of:
(a) dealing a plurality of cards;
(b) exchanging a card in accordance with a hold and/or a change;
(c) moving said player's piece, when a combination of a plurality of cards after the exchange is a predetermined combination, on said sugoroku board provided with a plurality of spaces by the number of spaces corresponding to the combination of said plurality of cards; and
(d) providing an award corresponding to a space at which said player's piece stopped.

5. A playing method of a card game comprising the steps of:
(a) dealing a plurality of cards;
(b) exchanging a card in accordance with a hold and/or a change;
(c) moving said player's piece, when a combination of a plurality of cards after the exchange is a predetermined combination, on said sugoroku board provided with a plurality of spaces by the number of spaces corresponding to the combination of said plurality of cards;
(d) executing a bonus game when said player's piece stops at a specific space;
(e) determining a prize to be offered in said bonus game; and
(f) offering the determined prize.

6. A playing method of a card game comprising the steps of:
(a) dealing a plurality of cards;
(b) exchanging a card in accordance with a hold and/or a change;
(c) moving said player's piece, when a combination of a plurality of cards after the exchange is a predetermined combination, on said sugoroku board provided with a plurality of spaces by the number of spaces corresponding to the combination of said plurality of cards;
(d) executing a bonus game in accordance with the combination of said plurality of cards when said player's piece stops at a specific space;
(e) determining a prize to be offered in said bonus game; and
(f) offering said the determined prize.
